(19) United States
(12) Patent Application Publication
(10) Pub. No.: US 2005/0182742 A1
(43) Pub. Date: Aug. 18, 2005

(54) Method and system for managing a portal

(75) Inventors: William James Griffin, Sammamish, WA (US); Guo-Wei Shieh, Sammamish, WA (US); Howard M. Crow III, Sammamish, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/781,970

(22) Filed: Feb. 18, 2004

(51) Int. Cl. G06F 17/30

(52) U.S. Cl. 707/1

(57) ABSTRACT

A system and method for managing a portal is described. A portal server application includes a portal manager in communication with a user interface of a web browser. The portal manager includes a database for storing metadata related to elements accessible from a portal. The user interface displays a navigational hierarchy of the elements that a user is authorized to access from the portal. The navigational hierarchy of elements is arranged in accordance with metadata in the database.

### BACKGROUND OF THE INVENTION

A web portal typically includes a hierarchy of viewable pages. Each page may include a link to another page within the portal or to a different portal. Portals are created and managed by manipulating information in a database which requires a high degree of technical sophistication. Portal creation and management is expensive because the services of a software developer are often employed. A way to simplify portal creation and management is required.

### SUMMARY OF THE INVENTION

The present invention is directed towards providing a system and method for managing a portal. According to one aspect of the invention, an element is selected from a navigational hierarchy. The element is associated with a location accessible from the portal. The navigational hierarchy is identified with metadata in a database. An action to be performed on the selected element is selected. Metadata associated with the selected action and the selected element is retrieved from the database. If the action is associated with a link, the location identified by the link is linked to. Otherwise, the action is performed with the retrieved metadata and the metadata in the database is updated based on the performed action.

According to another aspect of the invention, portal management is performed using a portal manager in communication with a user interface. The portal manager includes an element database. Metadata associated with elements accessible from the portal is stored in the element database. A navigational hierarchy of the elements accessible from the portal is displayed on the user interface. The navigational hierarchy of the elements is arranged in accordance with metadata in the element database.

According to another aspect of the invention, a security module authorizes user access to an element in the navigational hierarchy.

According to yet another aspect of the invention, the element and the action are selected using a web browser.

According to a further aspect of the invention, metadata associated with elements may be stored in and retrieved from a cache.

### BRIEF DESCRIPTION OF THE DRAWINGS

FIG. 1 illustrates a computing device that may be used according to an example embodiment of the present invention.

FIG. 2 is a functional block diagram generally illustrating a system for managing a portal, in accordance with an aspect of the present invention.

FIG. 3-7 show example screenshots of a user interface of a system for managing a portal, in accordance with other aspects of the present invention.

FIGS. 8-10 illustrate example code for a mechanism to manage a portal, in accordance with another example embodiment of the present invention.

FIG. 11 is an operational flow diagram illustrating a process for managing a portal, in accordance with yet another aspect of the present invention.

### DETAILED DESCRIPTION OF THE PREFERRED EMBODIMENT

Generally, the present invention is directed towards providing a system and method for managing a portal. A portal server application includes a portal manager in communication with a user interface of a web browser. The portal manager includes a database for storing metadata related to elements accessible from a portal. The user interface displays a navigational hierarchy of the elements that a user is authorized to access from the portal. The navigational hierarchy of elements is arranged in accordance with metadata in the database.

Portals conceptually provide a single point of access to aggregated information. The portal concept has been applied to general audiences on the Web (“Internet portals”), to organization-private web sites (“intranet portals”), and to specialized online communities of practice (“vertical portals” or “vortals”).

An intranet (often referred to as a private network) is the generic term for a collection of private computer networks within an organization. Intranets generally use standard network technologies such as Ethernet, TCP/IP, web browsers and web servers. An organization's intranet often enjoys Internet access that is firewalled from public access so that computers inside the intranet cannot be accessed directly from the public network. Although many schools and non-profit organizations have deployed intranets, intranets are predominately used as a corporate productivity tool that aids in the dissemination of private information. Besides email and groupware applications, intranets generally include access to internal web sites to disseminate information.

A common extension to an intranet, an extranet opens holes in the firewall to provide controlled access to outsiders. Extranets are computer networks that allow controlled access from the outside, generally for specific business or educational purposes. Extranets are extensions to, or segments of, private intranet networks that have been built in many corporations for information sharing and e-commerce. Most extranets use the Internet as the entry point for outsiders, a firewall configuration to limit access, and a secure protocol for authenticating users.

The primary goal of most portals is ease-of-use. Besides having a single point of access—a virtual front door—portals generally try to provide a rich navigation structure. Portals using web pages for their user interface will, for instance, often include numerous hyperlinks on the front page. An example portal is a web site, such as yahoo.com, where many elements are aggregated such as featured content, numerous hyperlinks, search capability, stock quotes, and customization content based on user locale. The customizable content can be identified with a user by a secure login procedure, an insecure login, the use of cookies, as well as other mechanisms to identify the user.

Illustrative Operating Environment

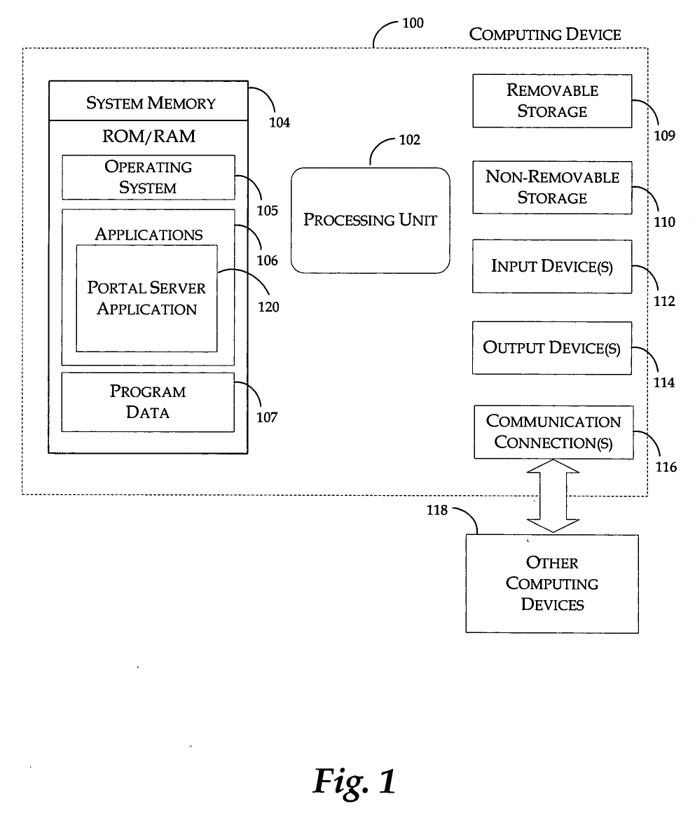

With reference to FIG. 1, one example system for implementing the invention includes a computing device, such as computing device 100. Computing device 100 may be configured as a client, a server, mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes portal server application 120. Portal server application 120 includes a hierarchy manager and a user interface which will be discussed in detail below.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Portal Management

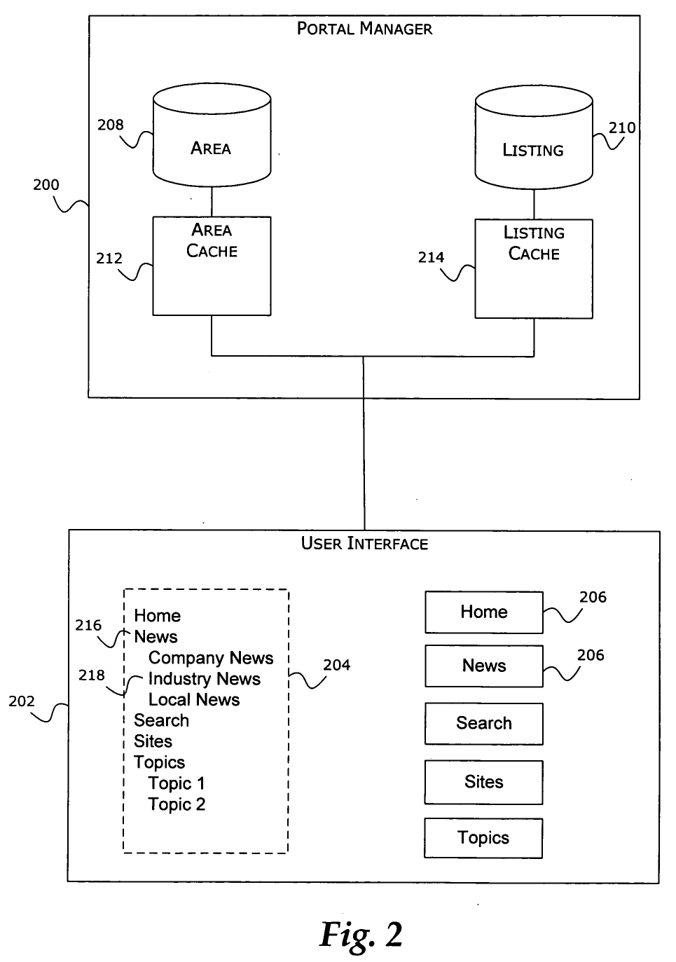

FIG. 2 is a functional block diagram illustrating a system for managing a portal server (often referred to as a portal). The system operates as a scalable portal server application such as Microsoft® Office SharePoint™ Portal Server 2003 manufactured by the Microsoft Corporation in Redmond, Wash. The system includes portal manager 200 arranged to communicate with user interface 202. User interface 202 displays navigational hierarchy 204 and areas 206. Portal manager 200 is arranged to manage and configure a portal. Portal manager 200 provides a tool set to design and implement security and time stamping features (discussed in detail below). Portal manager 200 includes area database 208, listing database 210, optional area cache 212, and optional listing cache 214.

Areas are locations within the portal that may be accessed by the user. An area organizes portal content by user-defined criteria. Area database 208 contains metadata associated with areas 216 in navigational hierarchy 204. The metadata provides information about the hierarchy of the area such that a user may navigate the portal from a web browser without the use of external tools.

Listings include internal links to a page or a resource (e.g., a relative link), external links to a page or a resource (e.g., a uniform resource locator (URL) link to the Internet), and hyper text markup language (html) text (e.g. an announcement. One area may have more than one listing associated with it. Listings associated with an area may be labeled and grouped. For example, in a programming area the listings may be grouped according to programming language.

Navigational hierarchy 204 is a centralized navigational structure for browsing the portal and related content. Navigational hierarchy 204 indicates how the areas that may be viewed within the portal are organized such that places within the portal may be easily described and located. In one embodiment, as shown in the figure, five areas (e.g., Home, News, Search, Sites, and Topics) may be accessed and viewed in the portal. However, additional areas may be included. Likewise, areas may be removed from navigational hierarchy 204. When an area administrator modifies navigational hierarchy 204 on one page, the update is reflected on every page in the portal.

Some areas, such as News area 216, include several subareas (e.g., Company News, Industry News, Local News, Topic 1, and Topic 2). Subareas may be referred to as children or descendent areas. News 216 is referred to as the parent of Industry News subarea 218.

When a user requests to view a page in the portal, the display shown on user interface 202 is created using web form controls to establish the components of the user interface such as navigational hierarchy 204 and areas 206. Metadata associated with the components is obtained from area database 208 and listing database 210 are utilized by the portal server application to arrange the components on user interface 202.

Area cache 212 and listing cache 214 are optional components that may be located in memory of portal manager 200. Caches 212, 214 facilitate performance and security of the portal. Caches 212, 214 area arranged to store a subset of the metadata when the metadata is retrieved from area and listing databases 208, 210. Thus, the next time that the same metadata is requested, the database need not be accessed because the information is already available in caches 212, 214. If the requested data is not in the cache, the data is retrieved from the database and a copy of the data is then stored in the cache.

In an example portal scenario, users are repeatedly viewing the same pages. Caches 212, 214 eliminate repeated data retrieval steps to enhance overall performance. The first user to access the page initiates retrieval from databases 208, 210. When another user accesses the same page, the page renders faster because the data is readily accessible from caches 212, 214.

Portal security may be based on the following forms of user authentication: anonymous authentication, basic authentication, integrated authentication, and certificates authentication. The authentication method is selected by configuring the portal.

Anonymous authentication provides access to users who do not have registered accounts on the server computer (e.g., web site visitors). An anonymous account is created for web services. The anonymous account is impersonated when the portal receives an anonymous request. Anonymous access to the portal may be enabled or disabled.

Basic authentication is an authentication protocol supported by most web servers and browsers. Although basic authentication transmits user names and passwords in easily decoded clear text, it has some advantages over more secure authentication methods. Basic authentication works through a proxy server firewall and ensures that a web site is accessible by almost any web browser. Basic authentication used in combination with certificates authentication can protect the user names and passwords, making user information more secure.

Integrated authentication encrypts user names and passwords in a multiple transaction interaction between client and server. Thus, integrated authentication is more secure than basic authentication. However, integrated authentication cannot be performed through a proxy server firewall, and some web browsers (most notably, Netscape Navigator®) do not support it.

Certificates authentication provides communications privacy, authentication, and message integrity for a TCP/IP connection. By using the security sockets layer protocol, clients and servers can communicate in a way that prevents eavesdropping, tampering, or message forgery. Certificates authentication helps secure authoring across firewalls and allows more secure remote administration of software services.

When data associated with an area is retrieved from databases 208, 210, all of the subareas and listings associated with the area may be stored in caches 212, 214 whether or not the user is authorized to access the subareas and listings. Caches 212, 214 then determine which areas and listings the user is authorized to access such that only the authorized listings and subareas are displayed on user interface 202. Since all of the subareas and listings associated with an area are stored in caches 212, 214, a subsequent request at the same page from a user having different security permissions is more likely to be satisfied directly from caches 212, 214. The request may yield a completely distinct set of subareas and listings based on the security permissions. The request is fulfilled quickly because the relevant information is retrieved from caches 212, 214 such that data retrieval from databases 208, 210 is not necessary.

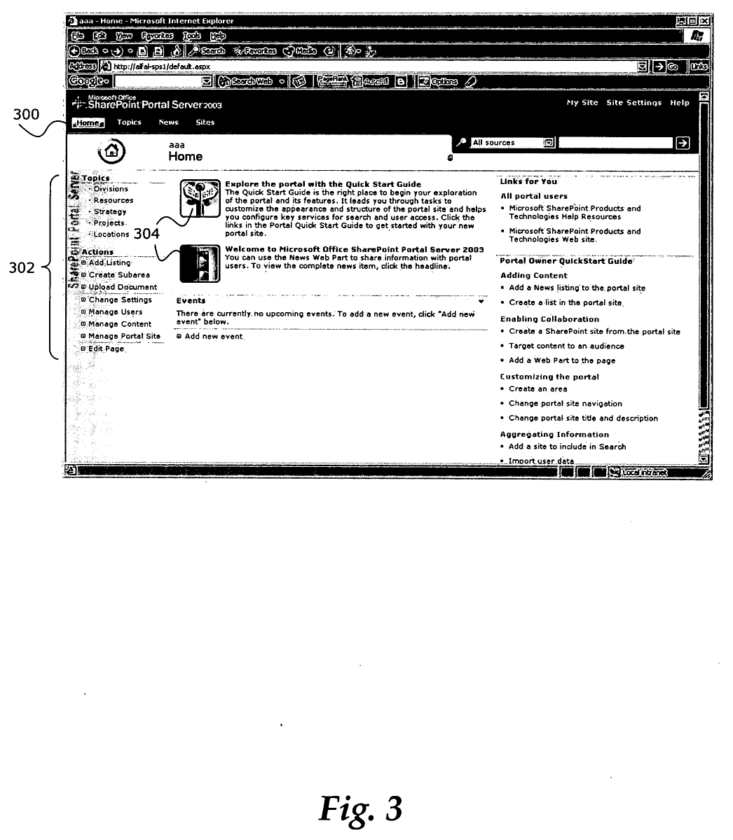

FIG. 3 shows an example screen shot of the user interface displaying a page associated with an area. The screen shot includes navigational bar 300, portal management tool 302, and listings 304 associated with the Home area. Navigational bar 300 shows areas that may be accessed in the portal. Accessible areas include Home, Topics, News, and Sites. Portal management tool 302 may include a navigational hierarchy tool and an action tool. The navigational hierarchy tool includes accessible areas, such as Topics, and any associated subareas, such as Divisions, Resources, Strategy, Projects and Locations. The action tool includes a list of authorized actions that are available to the user and associated with the current area. For example, the user is authorized to perform the eight actions (e.g., add listing, create subarea, upload document, change settings, manage users, manage content, manage portal site, and edit page) listed in portal management tool 302.

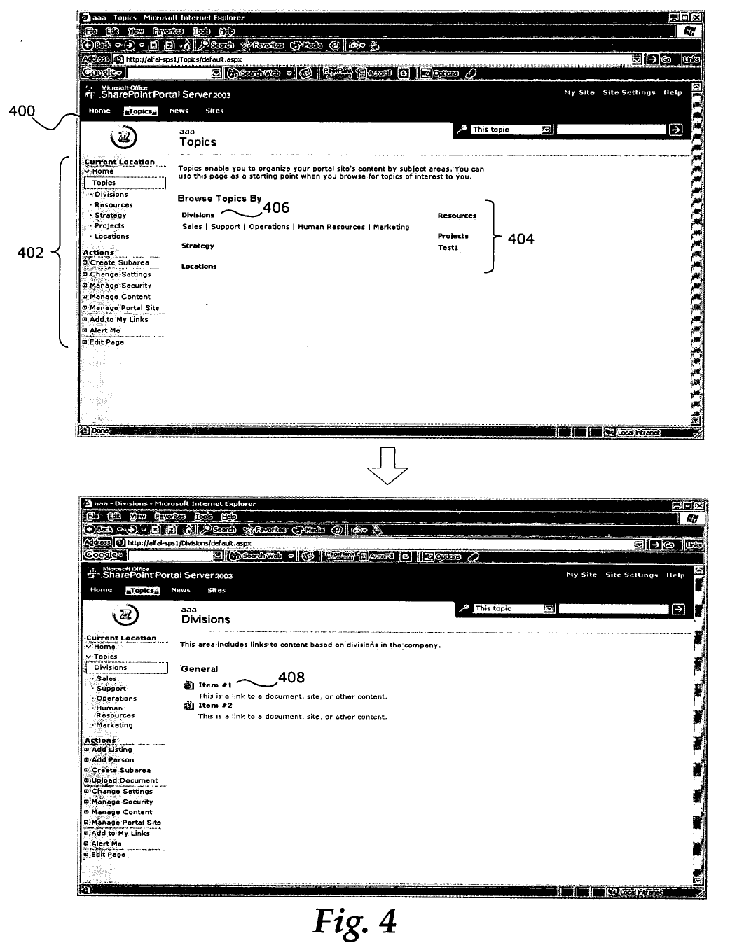

FIG. 4 shows example screen shots of the user interface displaying a page associated with an area (i.e., Topics) and a subarea (i.e., Divisions). The screen shot includes navigational bar 400, portal management tool 402, and subareas 404 associated with the Topics area. The actions available to the authorized user are displayed in portal management tool 402. The authorized actions are different than those listed in FIG. 3 because each user may have different security authorizations associated with each area. The lower screen shot appears on the user interface when the user selects Divisions subarea 406. Listings 408 are displayed on the user interface such that the user may link to places within the portal or outside the portal (e.g., via URL links).

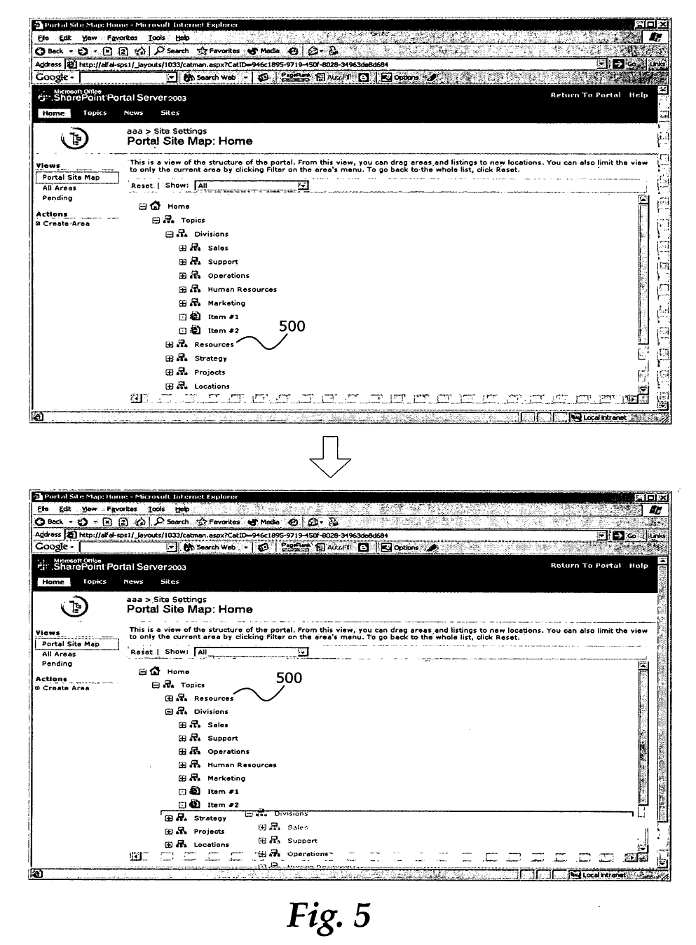

FIG. 5 shows example screen shots of the user interface displaying a navigational hierarchy of areas. In one embodiment, the areas and subareas of the navigational hierarchy are listed alphabetically by default. The hierarchy manager provides an authorized user with a tool for manually rearranging the navigational hierarchy. In another embodiment, the user may move the location of the area within the navigational hierarchy using drag-and-drop technology. For example, the user may click (e.g., select with a mouse button) on Resources area 500 and then drag and drop (e.g., move the mouse pointer and release the button) it at a new location as shown in the lower screen shot. The physical location of the area in the area database is not moved, only the logical location of the area as it appears in the navigational hierarchy is moved. In yet another embodiment, an authorized user may further change the view of the navigational hierarchy by adding or deleting areas.

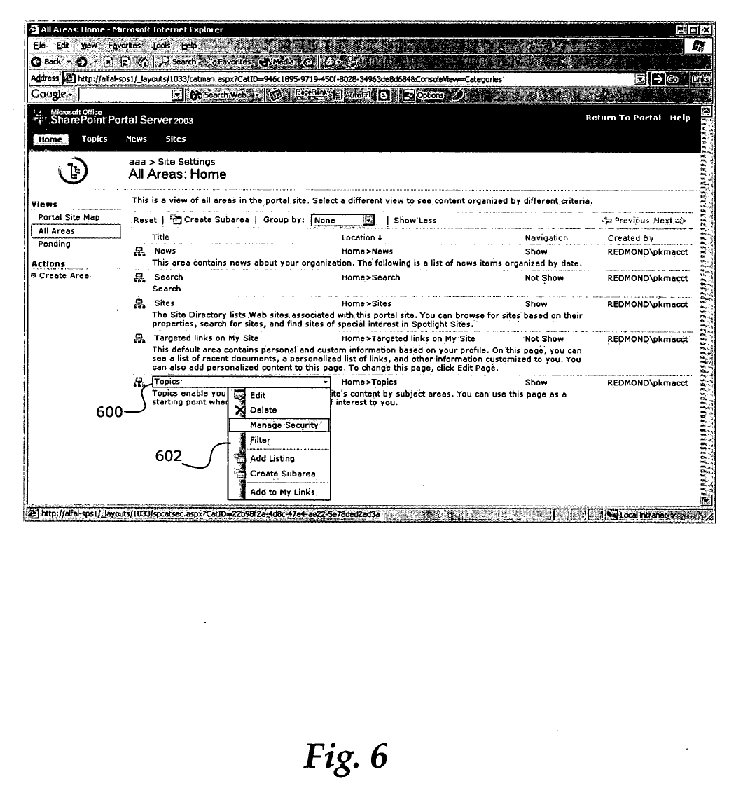

FIG. 6 is an example screen shot of the user interface displaying areas in the portal. The areas illustrated include News, Search, Sites, Targeted Links on My Site, and Topics. A user may manage an area by clicking (e.g. selecting with a mouse pointer and button) on the area name. As shown in the figure, a user may select Topics area 600 to view the available authorized actions. Menu 602 appears showing the available functions (actions) which include edit, delete, manage security, filter, add listing, create subarea, and add to my links. In the example shown, the user has selected the manage security function.

Each area has security settings associated with it that establish a user's scope of permissive activity. The security settings of an area may be inherited from its parent area by default. An area that inherits security settings from its parent may be moved within the navigational hierarchy such that the security settings of the area are dependent on a different area from the original parent. The moved area inherits the security settings from its new parent area as defined by the changed hierarchy. Security setting inheritance may be interrupted by directly changing the security settings associated with the area resulting in changes to inherited security settings associated with subareas.

Each area in the navigational hierarchy may have an assigned security role. Examples of security roles include reader, contributor, area administrator, and site manager. In one example, areas accessible by everyone default to the reader role. A user who is authorized to access and manage the entire site is assigned the site manager role. An area administrator is authorized to manage area settings. For example, the area administrator may have facility to add links and pages to the authorized area, and assign security roles to an area for viewing by a select group of users.

Security privileges may be granted on a per area basis. In one embodiment, an area may be assigned more than one role. For example, some users may be assigned a reader role to an area, while other users are assigned a contributor role. Contributors are authorized to submit links and pages to the area administrator for approval or rejection, also referred to as filtering.

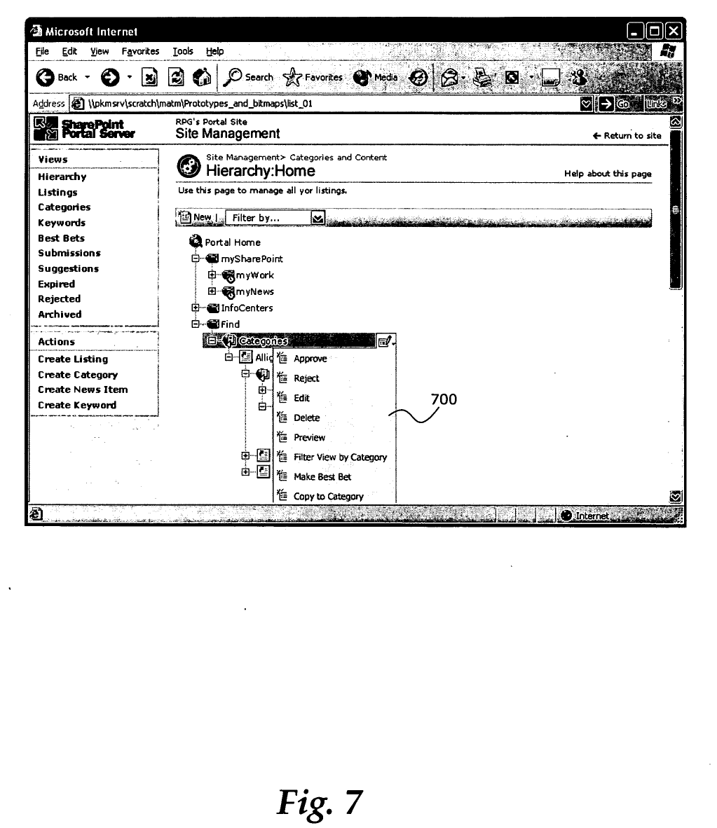

FIG. 7 is an example screen shot of the user interface displaying an area management menu associated with an area in the navigational hierarchy. A user who is assigned a contributor role for a given area may submit a link to the associated area administrator. The area administrator then filters the link by either approving or rejecting the submission using area management menu 700. The link becomes available to authorized users when the area administrator approves the submission.

In one embodiment, listings and areas that a user is not authorized to access do not appear on the user interface and are masked out of an unauthorized user's view. For example, a link to a management console that a site manager uses for filtering is only visible on the site manager's user interface. Furthermore, a user is denied access to an unauthorized listing or area even if the user attempts to directly link to the secure area in an attempt to override security permissions by entering a URL link to the listing or area in the web browser.

Areas and listings may be time stamped such that they have scheduled appearances and removals. An area administrator may create an area or listing and assign a date when it becomes published on the portal. Users cannot access the area or listing using the navigational hierarchy until the assigned date. Similarly, an area or a listing may be assigned a removal date such that the area or listing is removed from the navigation control on the assigned date. In one embodiment, the area or listing may be directly accessed on the browser via the URL even though the area or listing is not accessible on the portal via the navigational controls.

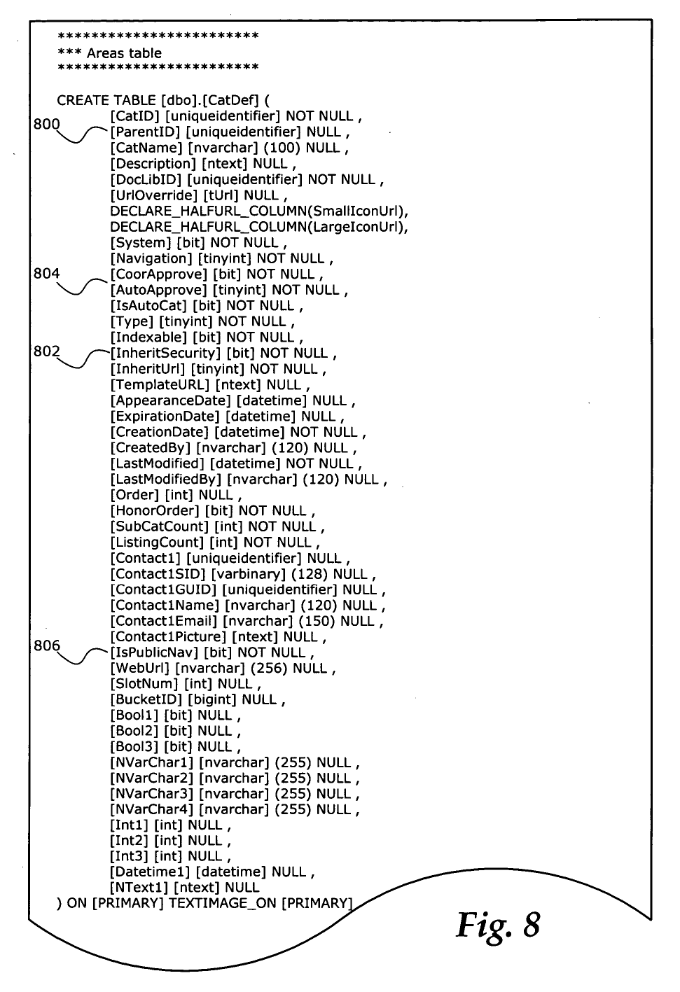

FIG. 8 includes the code for an example application program interface (API) that creates an example area database. For example, ParentID 800 is a database entry that identifies the hierarchical parent of an area. By changing ParentID 800, a parent association for an area can be moved to another location in the navigational hierarchy without disrupting the subareas or listings associated with the original parent area. InheritSecurity 802 is a database entry that is associated with the security settings of the parent area. By changing InheritSecurity 802, the security settings associated with an area are no longer inherited from the parent area. CoorApprove and AutoApprove 804 are associated with database entries that are used by the portal server application to filter an area. IsPublicNav 806 is associated with a database entry that is used by the portal server application to determine whether public users may navigate the area (i.e., security settings associated with extranet and intranet).

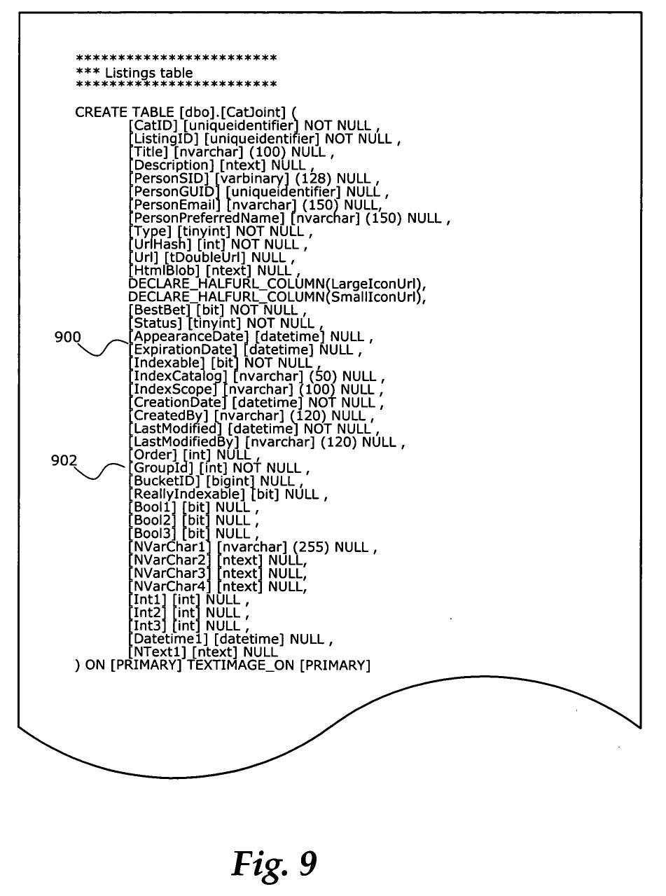

FIG. 9 includes the code for an example API that creates an example listing database. For example, AppearanceDate and ExpirationDate 900 are associated with database entries that are related to the time stamping feature described above. GroupId 902 is associated with a database entry that identifies a group that a user may be a member of. GroupId 902 is associated with security roles as described above.

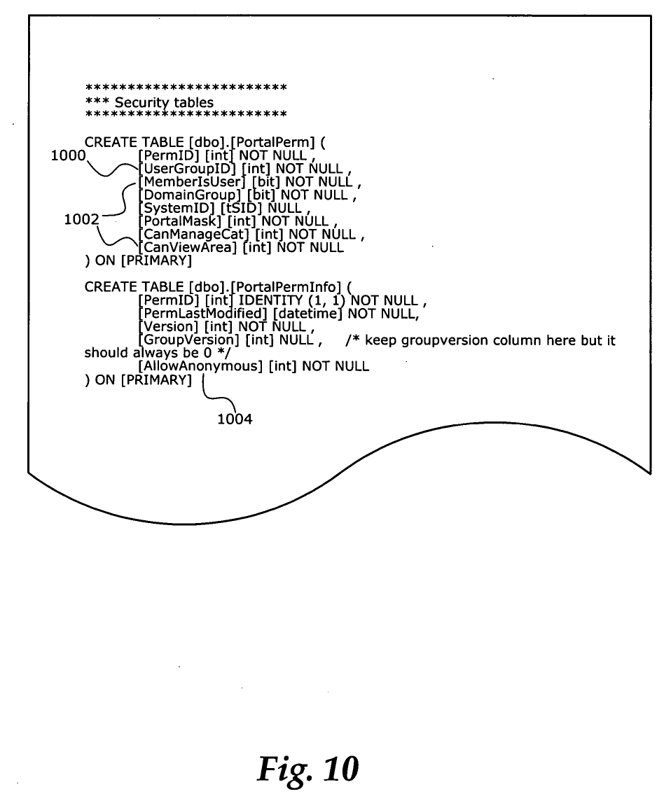

FIG. 10 includes the code for an example API that defines the security level associated with database access. For example, UserGroupID 1000 is a database entry associated with the security role of the user as described above. MemberisUser and CanViewArea 1002 are database entries associated with the determination of which users are granted access to an area. AllowAnonymous 1004 is a database entry associated with the determination of whether anonymous user action is allowed.

The API set provides for the creation, updating, and deletion of areas and listings in the navigational hierarchy, and the security features such that the user interface only displays the authorized areas and the listings. The APIs cache the area hierarchy for users that only have read privileges. Users with write privileges bypass the cache and may access live data such that a current view of the area hierarchy is presented on the user interface.

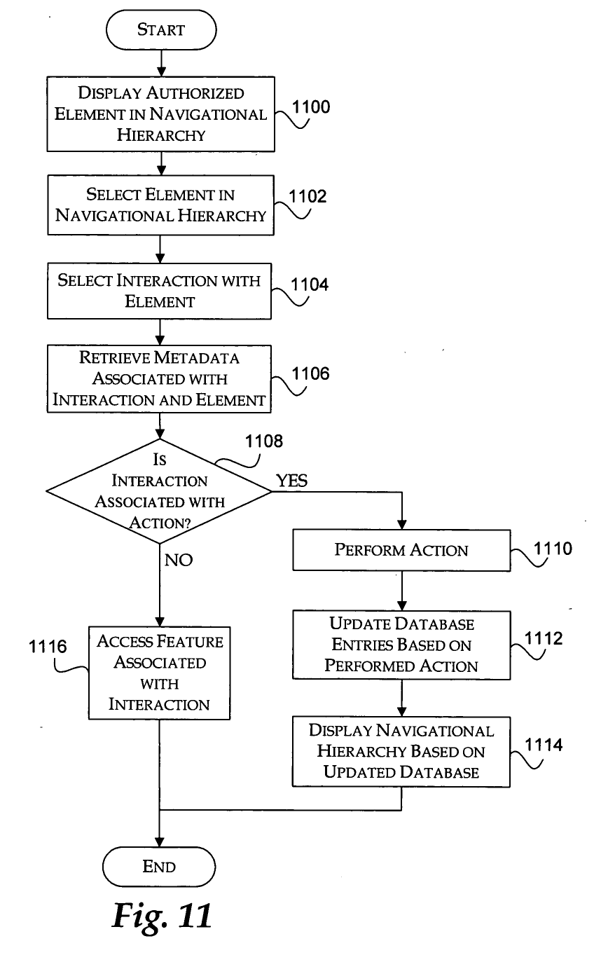

FIG. 11 illustrates a process for managing a portal, in accordance with aspects of the invention. After a start block the process moves to block 1100 where an authorized element (i.e., user authentication is satisfied) is displayed in the navigational hierarchy of the user interface. Elements that a user is not authorized to access do not appear in the navigational hierarchy.

Proceeding to block 1102 an element within the navigational hierarchy is selected. The selection may be accomplished using a keystroke, a command, a string, a direct link to a URL, or a selection means such as a mouse. The elements may be areas, subareas, and listings within the portal as previously described.

Moving to block 1104, the user selects an interaction to be applied to the element. Upon selecting the interaction, the process moves to block 1106 where metadata associated with the selected element and the selected interaction is retrieved from a database. A subset of the retrieved metadata may be stored in a cache such that the next time the interaction is selected, the metadata may be directly retrieved from the cache.

Transitioning to decision block 1108, a determination is made whether the interaction is associated with an action. The action may include one of the following: delete element, edit element, change security settings associated with element, move element, filter (i.e., approve/reject) element, create a new listing/subarea in an area associated with the element, time stamp element, and create a new element in the navigational hierarchy.

If the interaction is not associated with an action, the process proceeds to block 1116. If the interaction is associated with an action, the process moves to block 1110.

Continuing to block 1110, the action associated with the interaction is performed on the element. Moving to block 1112, the database entries related to the element are updated in accordance with the performed action. Advancing to block 1114, the navigation hierarchy is displayed on the user interface based on the updated database. The process then terminates at an end block.

Returning to block 1116, a feature associated with the interaction is accessed. The feature may be a link, resource or web page that is external to the portal (e.g., internet) or internal (e.g., intranet). The process then terminates at the end block.

The above specification, examples and data provide a complete description of the manufacture and use of the composition of the invention. Since many embodiments of the invention can be made without departing from the spirit and scope of the invention, the invention resides in the claims hereinafter appended.

1. A method for managing a portal, comprising:
selecting an element from a navigational hierarchy, the selected element being associated with a location accessible from the portal, the navigational hierarchy being identified with metadata in a database;
selecting an interaction to be performed on the selected element;
retrieving metadata associated with the selected interaction and the selected element;
when the interaction corresponds to an action, performing the action with the retrieved metadata and updating the metadata in the database based on the performed action; and
accessing a feature associated with the interaction when the interaction does not correspond to an action.

2. The method of claim 1, wherein the element is at least one of an area, a subarea, a listing, an intranet site, and an extranet site.

3. The method of claim 1, wherein the element comprises a listing, and wherein the listing is arranged to provide access to at least one of a link, a resource and a page from the portal.

4. The method of claim 3, wherein the listing is arranged to provide access to at least one of the link, the resource, and the page external to the portal.

5. The method of claim 1, wherein the feature is at least one of a link, a resource and a page.

6. The method of claim 1, further comprising displaying the navigational hierarchy in accordance with the updated metadata.

7. The method of claim 1, further comprising authorizing user access to the element in the navigational hierarchy.

8. The method of claim 7, further comprising displaying the element in the navigational hierarchy that a user is authorized to access.

9. The method of claim 7, further comprising inheriting user authorization to access the element from a parent element, wherein metadata identifies the parent element and the inherited user authorization.

10. The method of claim 1, wherein selecting the element and selecting the action is performed using a web browser.

11. The method of claim 1, wherein the selecting the element and selecting the action is performed by a direct link provided in a uniform resource locator in a web browser.

12. The method of claim 1, wherein performing the action comprises adding an element to the navigational hierarchy.

13. The method of claim 12, wherein adding the element further comprises adding an element to the navigational hierarchy at a pre-assigned time.

14. The method of claim 1, wherein performing the action comprises removing an element from the navigational hierarchy.

15. The method of claim 14, wherein removing the element further comprises removing the element from the navigational hierarchy at a pre-assigned time.

16. The method of claim 1, wherein performing the action comprises filtering the element.

17. The method of claim 1, wherein performing the action comprises storing a subset of the retrieved metadata in a cache.

18. The method of claim 17, wherein retrieving metadata comprises retrieving metadata associated with the element from the cache.

19. The method of claim 1, further comprising storing subareas and listings associated with a currently selected element in a cache.

20. The method of claim 19, further comprising retrieving the subareas and listings that a user is authorized to access from the cache.

21. A system for managing a portal, comprising:
a portal manager comprising an element database, the element database storing metadata associated with elements accessible from the portal; and
a user interface in communication with the portal manager, the user interface displaying a navigational hierarchy of the elements accessible from the portal, wherein the navigational hierarchy of the elements is arranged in accordance with metadata in the element database.

22. The system of claim 21, wherein the element database comprises an area database and a listing database, the area database storing metadata associated with areas accessible in the portal, the listing database storing metadata associated with links accessible from the portal.

23. The system of claim 22, wherein the portal manager further comprises an area cache and a listing cache, the area cache storing a subset of metadata retrieved from the area database, the listing cache storing a subset of metadata retrieved from the listing database.

24. The system of claim 23, wherein metadata associated with the element is retrieved from the area cache and the listing cache.

25. The system of claim 21, wherein the portal manager further comprises a security module, wherein the security module is configured to:
identify a user requesting access; and
authenticate access to at least one of an element and metadata based on the identified user.
